(19) United States
(12) Patent Application Publication
(10) Pub. No.: US 2010/0289410 A1
(43) Pub. Date: Nov. 18, 2010

(54) Illumination device and control method thereof

(75) Inventors: Shang-Hsuang Wu, Hsinchu (TW); Ken-Chih Chang, Hsinchu (TW); Chih-Cheng Chou, Hsinchu (TW); Chin-Hao Wu, Hsinchu (TW)

Correspondence Address: BACON & THOMAS, PLLC, 625 SLATERS LANE, FOURTH FLOOR, ALEXANDRIA, VA, 22314-1176, US

(73) Assignee: YOUNG GREEN ENERGY CO., Hsinchu (TW)

(21) Appl. No.: 12/662,206

(22) Filed: Apr. 6, 2010

(30) Foreign Application Priority Data
May 18, 2009 (TW) 098116409

(51) Int. Cl. H01J 61/52

(52) U.S. Cl. 315/112

(57) ABSTRACT

An illumination device and a control method thereof are provided. The illumination device includes a fan and a light emitting diode module capable of emitting a light beam. The control method includes: detecting a fan signal of the fan; determining whether an operation of the fan is abnormal according to the fan signal, wherein a driving current of the LED module is reduced when the operation of the fan is determined to be abnormal; and a driving current of the LED module is reduced to a predetermined rang of the normal rated driving current when the fan is determined to be stop according to the fan signal.

### CROSS-REFERENCE TO RELATED APPLICATION

This application claims the priority benefit of Taiwan application serial no. 98116409, filed on May 18, 2008. The entirety of the above-mentioned patent application is hereby incorporated by reference herein and made a part of this specification.

### BACKGROUND OF THE INVENTION

1. Field of the Invention

The invention generally relates to an illumination device, and more particularly, to a light emitting diode illumination device with a fan and a control method thereof.

2. Description of Related Art

The recent high intensity light emitting diode (LED) is still expensive and the LED module of an LED lighting device includes more than one LED. For the LED illumination device, the cost of the LED module is expensive. Passive heat dissipation devices, for example, heat dissipation column or heat dissipation fin, are used for some LED modules and active heat dissipation devices, for example, a fan or a thermoelectric cooling chip, is used to keep the LED module at an appropriate working temperature. Moreover, an overheating protection design may avoid the LED module being burned.

In a conventional overheating protection method of the LED module, power generated by the power supply of the LED module has been shut off to the LED module when a temperature sensor detects an over-high temperature. Another conventional overheating protection method of the LED module is to adjust the driving current of the LED module according to the detected temperature, so as to regulate the temperature of the LED module.

When the LED lighting device adopts a passive heat dissipation mechanism, i.e. natural convection or heat conducting, the volume and the weight of the radiator may become very large and heavy and thus, the heat sink becomes a heavy burden for the LED lighting device companies. When the LED lighting device adopts an active heat dissipation mechanism, the volume of the heat sink becomes smaller, however, when the fan is broken down, the LED module may be burned. In conclusion, how to improve the method of overheating protection for the LED module is an important issue for the LED lighting device companies.

### SUMMARY OF THE INVENTION

Accordingly, the invention provides a control method of an illumination device capable of dissipating heat by the light emitting diode (LED) module and protecting the LED module of the illumination device from overheating.

The invention provides an illumination device capable of dissipating heat by the LED module and protecting the LED module of the illumination device from overheating.

One embodiment of the invention provides a control method of an illumination device. The illumination device includes a fan and a light emitting diode module capable of emitting a light beam. The control method includes: detecting a fan signal of the fan; determining whether an operation of the fan is abnormal according to the fan signal, wherein a driving current of the LED module is reduced when the operation of the fan is determined to be abnormal; and a driving current of the LED module being reduced to a predetermined rang of the normal rated driving current when the fan is determined to be stop according to the fan signal.

One embodiment of the invention provides an illumination device. The illumination device includes LED module, a fan, a driver, and a control circuit. The LED module includes at least one light emitting diode. The fan is capable of generating a convective air flow inside of the illumination device and generating a fan signal. The driver is electrically connected to the LED module and capable of driving the LED module to emit a light beam. The control circuit is electrically connected to the fan and the driver and is capable of receiving the fan signal and determining whether the operation of the fan is abnormal according to the fan signal. Therein, a driving current of the LED module is reduced by the control circuit when the operation of the fan is determined to be abnormal; and the driving current of the LED module is reduced to predetermined range of the normal rated driving current by the control circuit when the fan is determined to be stop according to the fan signal.

In one embodiment of the invention, the control circuit sends an abnormal signal to a control center outside of the illumination device when the operation of the fan is determined to be abnormal.

In one embodiment of the invention, the illumination device further includes a thermal sensor electrically connected to the control circuit and the thermal sensor is configured to detect an environment temperature outside of the illumination device. The control circuit determines a reduced level of the driving current according to the environment temperature when the operation of the fan is determined to be abnormal.

In one embodiment of the invention, the fan further includes an operation detector, and the operation detector is configured to generate the fan signal according to the operation of the fan.

In one embodiment of the invention, the predetermined range is greater than or equal to 30% and less than or equal to 90%.

In one embodiment of the invention, the fan further includes a pulse generator configured to generate the fan signal and a frequency of the fan signal is in direct proportion to the rotation speed of the fan. In the embodiment, the control circuit determines a reduced level of the driving current according to the frequency of the fan signal when the operation of the fan is determined to be abnormal.

In one embodiment of the invention, the control circuit adjusts the driver by using pulse width modulation to drive the driving current of the LED module.

In one embodiment of the invention, the control circuit adjusts the driver by adjusting the voltage to drive the driving current of the LED module.

In the embodiments of the invention, for the operation of the fan, a convective air flow is generated inside of the illumination device for heat dissipation and protecting the LED module from overheating. The illumination device determines whether the operation of the fan is abnormal according to the detected fan signal. When the operation of the fan is determined to be abnormal, an overheating protection mechanism is generated by reducing the driving current of the LED module to avoid the LED module burning down.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of an illumination device according an embodiment of the invention.

FIG. 2 is a flow chart of a control method of the illumination device according an embodiment of the invention.

FIG. 3 is a relationship diagram between a fan signal Sf of an R-type fan and time.

FIG. 4 is a relationship diagram between a fan signal Sf of an F-type fan and time.

FIG. 5 is a relationship diagram between a ratio of the driving current I of the module to a normal rated driving current and time according to an embodiment of the invention.

FIG. 6 is a relationship diagram between a ratio of the driving current Ito a normal rated driving current and an environment temperature.

FIG. 7 is a relationship diagram between a ratio of the driving current Ito a normal rated driving current and an rotation speed.

FIG. 8 is a block diagram of an illumination device according another embodiment of the invention.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

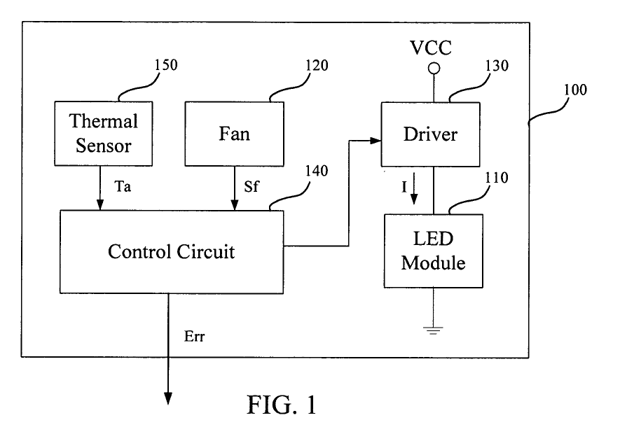

Please Refer to FIG. 1, an illumination device 100 includes a light emitting diode (LED) module 110, a fan 120, a driver 130, and a control circuit 140. The LED module 110 includes at least one LED and one end of the LED module is grounded. The fan 120 is capable of generating a convective air flow inside of the illumination device 100 to dissipate heat. The fan 120 is electrically connected to the control circuit 140 and is capable of generating a fan signal Sf to the control circuit 140. The driver 130 is electrically connected to a voltage VCC, the LED module 110, and the control circuit 140. The driver 130 is capable of driving the LED module 110 to emit a light beam. The control circuit 140 is capable of receiving the fan signal Sf and controlling the operation of the driver 130. The control circuit 140 determines whether the operation of the fan 120 is abnormal according to the fan signal Sf, wherein the driving current I of the LED module 110 is reduced to avoid the LED module 110 from overheating when the fan 120 is determined to be abnormal; and the driving current I is reduced to fall in a predetermined range of the normal rated driving current of the LED module 110 when the fan 120 is determined to be stop according to the fan signal Sf. In one embodiment of the invention, the predetermined range is greater than or equal to 30% and less than or equal to 90%. In one embodiment of the invention, the control circuit 140 sends an abnormal signal Err to the control center outside of the illumination device 100 to notify the abnormal operation of the fan 120.

In one embodiment of the invention, the illumination device 100 further includes a thermal sensor 150. The thermal sensor 150 is electrically connected to the control circuit 140 to detect the environment temperature Ta outside of the illumination device 100. The control circuit 140 determines a reduced level of the driving current I according the environment temperature Ta when the fan 120 is determined to be abnormal.

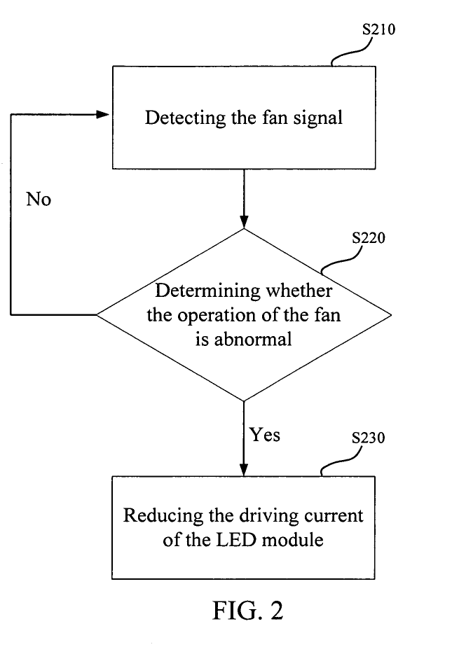

Referring to FIG. 1 and FIG. 2, FIG. 2 is a flow chart of a control method of the illumination device according an embodiment of the invention. In this embodiment, the control method of the illumination device 100 includes the following steps. At first, step S210 is performed. The control circuit 140 detects the fan signal Sf of the fan 120.

Afterwards, step S220 is performed. The control circuit 140 determines whether the operation of the fan 120 is abnormal. Therein, when the fan 120 is determined to be abnormal, step S230 is performed, otherwise back to step S210. In step S230, the control circuit 140 reduces the driving current I of the LED module 110 to lower the consumed power of the LED module 110, so as to avoid the LED module 110 form overheating In the embodiment of the invention, the illumination device 100 adopts the fan 120 to generate the convective air flow for heat dissipation and to avoid the LED module 110 working at over-high temperature. It is determined whether the operation of the fan 120 is abnormal by detecting the fan signal Sf. The driving current I of the LED module 110 is reduced to avoid the LED module 110 from overheating or burning down the LED module 110 due to the failed fan 120 when the operation of the fan 120 is determined to be abnormal.

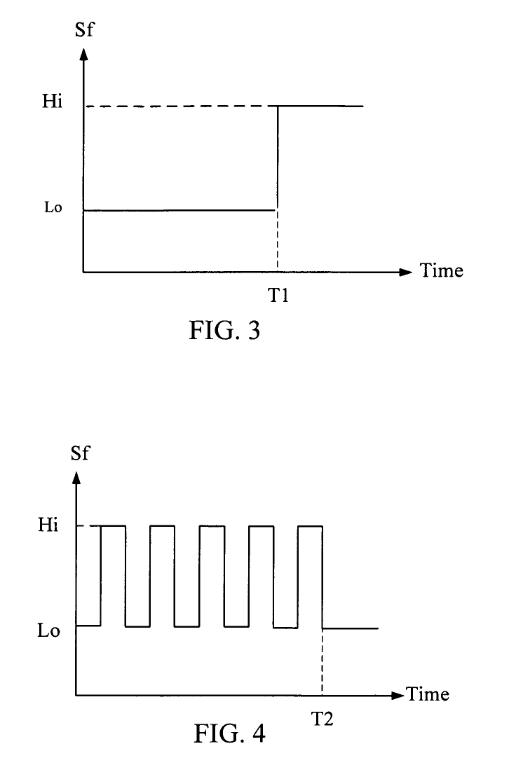

In one embodiment of the invention, the fan 120 is an R-type fan. Please refer to FIG. 3 for understanding the features of the R-type fan. FIG. 3 is a relationship diagram between the fan signal Sf of the R-type fan and time, wherein the vertical axis stands for a logical level of the fan signal Sf and the horizontal axis stands for time. The R-type fan includes an operation detector configured to detect the fan signal Sf according to the operation of the fan. When the fan 120 is the R-type fan, the operation detector is configured to generate the fan signal Sf corresponding to the operation of the fan 120, wherein when the fan signal Sf is at a low logical level Lo, the operation of the fan 120 is normal and when the fan signal Sf is at a high logical level Hi, the operation of the fan 120 is abnormal. The logical level of the fan signal Sf may correspond to different operation state of the fan 120 and the definition of the logical level of the fan signal Sf could be changed thereby. For example, when the fan signal Sf is at a low logical level Lo, the operation of the fan 120 is abnormal and when the fan signal Sf is at a high logical level Hi, the operation of the fan 120 is normal. The control circuit 140 determines whether the operation of the fan 120 is abnormal according the logical level of the fan signal Sf. Taking FIG. 3 for example, after the time T1, the low logical level Lo of the fan signal Sf changes to the high logical level Hi and thus the control circuit 140 determines operation of the fan 120 is abnormal.

In one embodiment of the invention, the fan 120 is a pulse width modulation (PWM) type fan or an F-type fan. Please refer to FIG. 4 for the features of the PWM type fan or R-type fan. FIG. 4 is a relationship diagram between the fan signal Sf of the F-type fan and time. In FIG. 4, the vertical axis stands for a logical level of the fan signal Sf and the horizontal axis stands for time. The PWM type fan or the R-type fan includes a pulse generator configured to generate a fan signal Sf and the frequency of the fan signal Sf is in direct proportion to a rotation speed of the fan. In other words, the higher the frequency of the fan signal Sf is, the faster the fan 120 rotates; the lower the frequency of the fan signal Sf is, the slower the fan 120 rotates. When the fan 120 is a PWM type fan or an F-type fan, the pulse generator is capable of generating the fan signal Sf corresponding to the rotation speed of the fan 120. The fan signal Sf is a frequency signal. The control circuit 140 calculates the rotation speed of the fan 120 according to the frequency of the fan signal Sf. When the fan 120 stops rotating, the fan signal Sf may stay at the low logical level Lo or the high logical level Hi and no more pulses are generated. The control circuit 140 determines whether the operation of the fan 120 is abnormal according to the frequency of the fan signal Sf. For example, when the rotation speed of the fan 120 falls in a numerical range, the operation of the fan 120 is defined normal, when the rotation speed falls out of the numerical range, the operation of the fan 120 is defined abnormal.

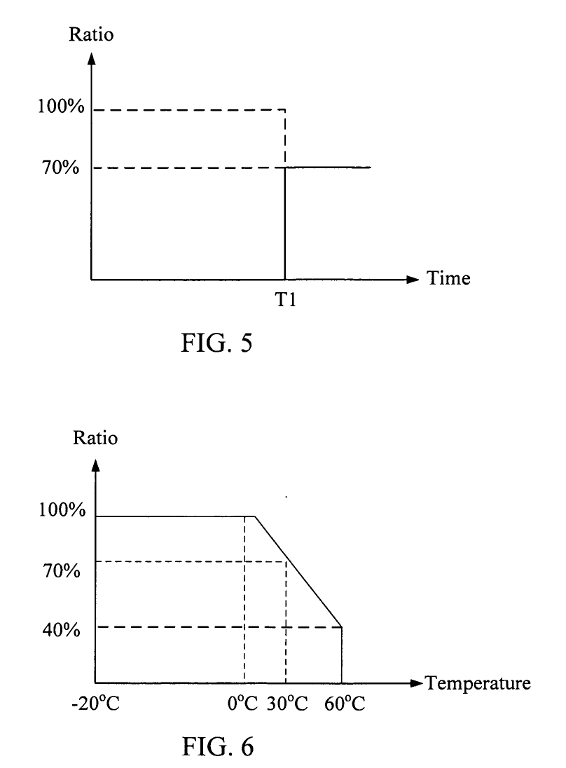

Refer to FIG. 5 and FIG. 3 for understanding the modulation of the driving current I of the LED module 110. FIG. 5 is a relationship diagram between a ratio of the driving current I of the module to a normal rated driving current and time according to an embodiment of the invention. In FIG. 5, the vertical axis stands for a ratio of the driving current I to the normal rated driving current and the horizontal axis stands for time. In the embodiment of the invention, the fan 120 is R-type fan, and the fan signal Sf generated by the fan 120 is shown as the one in FIG. 3. The fan signal Sf upgrades from low logical level Lo to high logical level at the time T1. In other words, the fan 120 becomes abnormal at the time T1 and in the situation, the control circuit 140 detects the change in logical level of the fan signal Sf. Thus the control circuit 140 controls the driver 130 to reduce the driving current I of the LED module 110 from 100% normal rated driving current to 70% normal rated driving current to avoid the LED module 110 from overheating or burning down the LED module 110 in the condition of the fan 120 being failed. In the embodiment, the reduced level of the driving current I is 30% (100% minus 70%) of the normal rated driving current but not limited to this. The principle of the reduced level of the driving current I is: the reduced driving current I could still drive the LED module 110 to emit a light beam and the LED module 110 doesn't be overheated or burnt when the operation of the fan 120 is abnormal. Accordingly, the reduced driving current could drive the LED module 110 to emit a light beam, when the fan 120 is failed and the illumination device 100 could provide a stable light source and not break down suddenly. With the illumination device and its applications, for example, a street lamp, it is more convenient and safer for users.

The modulation method is not limited to the above mentions. In one embodiment of the invention, the illumination device 100 includes a thermal sensor 150. When the control circuit 140 determines the operation of the fan 120 is abnormal, the control circuit 140 determines the reduced level of the driving current I according to a differential value between the environment temperature Ta and an initial upper limit threshold. For example, Taking 5° C. as an arithmetic progression, 5% of the driving current is reduced for each arithmetic progression. When the environment temperature Ta is 5° C. higher than the upper limit threshold, the driving current I is 95% of the normal rated driving current; when the environment temperature Ta is 10° C. higher than the upper limit threshold, the driving current I is 90% of the normal rated driving current. In one embodiment of the invention, the modulation range of the driving current I is greater than or equal to 30% and less than or equal to 100% of the normal rated driving current.

FIG. 6 is a relationship diagram between a ratio of the driving current Ito a normal rated driving current and an environment temperature. Referring to FIG. 6, the vertical axis stands for a ratio of the driving current I to the normal rated driving current, the horizontal axis stands for a environment temperature Ta, and the applicable temperature range for the illumination device 100 is greater than or equal to −20° C. and less than or equal to to 60° C. In the embodiment of the invention, the fan 120 includes an R-type fan, a PWM type fan or an F-type fan. The thermal sensor 150 detects the environment temperature Ta and the control circuit 140 determines the reduced level of the driving current I according to the environment temperature Ta. For example, when the fan 120 is determined to be stop and the environment temperature Ta is above 0° C. and under 60° C., the driving current I is modulated as a proportion of the normal rated driving current. As shown in FIG. 6, when the environment temperature Ta is under 0° C., the reduced proportion of the driving current I is 0%, and thus the driving current I is equivalent to the normal rated driving current; when the environment temperature Ta is 30° C., the reduced proportion of the driving current I is 30%; when the environment temperature Ta is 60° C., the reduced proportion of the driving current I is 60%; when the environment temperature Ta is above 60° C., the reduced proportion of the driving current I is 100%, and the driving current I is reduced to zero, so as to shut down the LED module 110. In the embodiment, the modulation range of the driving current I is greater than or equal to 0% and less than or equal to 100% of the normal rated driving current, but not limited to it. The principle of the modulating the driving current I is: the reduced driving current I could still drive the LED module 110 to emit a light beam and the LED module 110 doesn't be overheated or burned when the fan 120 is stop.

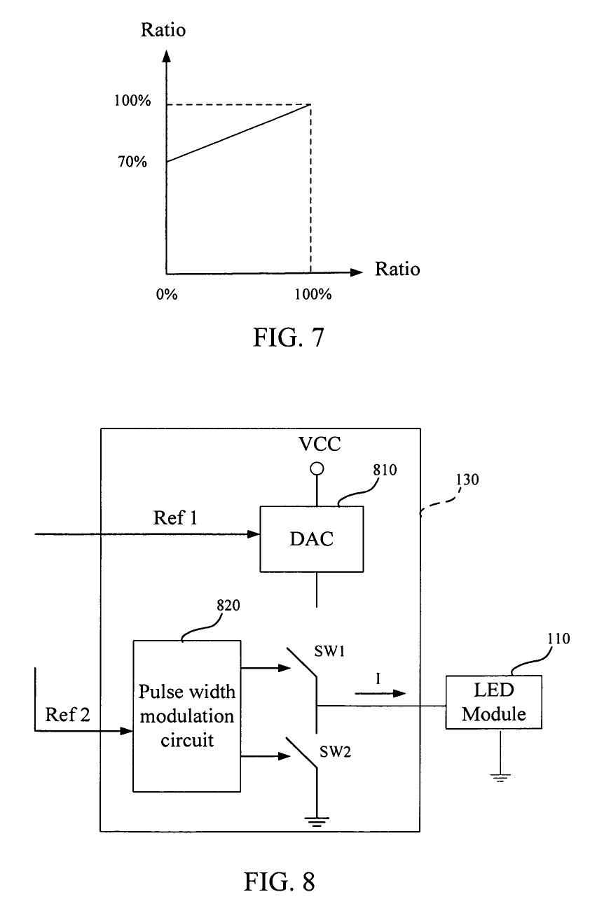

Referring to FIG. 7, the vertical axis stands for the ratio of the driving current Ito the normal rated driving current and the horizontal axis stands for the ratio of the rotation speed of the fan 120 to the normal rated rotation speed. When the operation of the fan 120 is normal, the rotation speed of the fan 120 is at normal rated rotation speed and the driving current I is normal rated driving current. When the rotation speed of the fan 120 slows down due to ageing or other reasons, the control circuit 140 determines the reduced level of the driving current I according to the rotation speed of the fan 120. The modulation of the driving current I is described as below. When the rotation speed of the fan 120 is at normal rated rotation speed, the driving current I is 100% of the normal rated driving current; when the rotation speed of the fan 120 is zero, the driving current I is 70% of the normal rated driving current; and when the rotation speed of the fan 120 is between normal rated rotation speed and zero, the driving current I is reduced by equal proportion. For example, when the rotation speed of the fan 120 is 80% of the normal rated rotation speed, the driving current I is 94% (70%+(100−70)×80%) of the normal rated driving current. Since the rotation speed of the fan 120 is in direct proportion to the frequency of the fan signal Sf, the control circuit 140 determines the reduced level of the driving current I directly according to the frequency of the fan signal Sf. In the embodiment of the invention, the modulation range of the driving current I is greater than or equal to 70% and less than or equal to 100% of the normal rated driving current but not limited to it. The principle of the modulation of the driving current I is: the reduced driving current I could still drive the LED module 110 to emit a light beam, and the LED module 110 could not be overheated or burned when the rotation speed of the fan 120 slows down.

In another embodiment of the invention, when the illumination device 100 includes a thermal sensor 150, the PWM type fan or the F-type fan, the driving current is reduced according to the environment temperature Ta and the rotation speed of the fan. The detail description may refer to the embodiments of FIG. 5 and FIG. 7.

Referring to FIG. 8, FIG. 8 is a block diagram of an illumination device according another embodiment of the invention. In the embodiment, the driver 130 includes a direct to direct conversion circuit, for example, a buck converter, a boost converter or a buck-boost converter. The driver 130 of the embodiment includes a digital to analog converter (DAC) 810, a pulse width modulation (PWM) circuit 820, a switch SW1, and a switch SW2. The switch SW1 and Switch SW2 are electrically connected to the DAC 810, the PWM circuit 820, and the LED module 110. The DAC 810 receives a control circuit signal Ref1 transmitted from the control circuit 140 and sets the wave crest level of the pulse outputted from the driver 130. The control signal Ref1 is configured to modulate the voltage of the pulse outputted from the driver 130, so as to modulate the driving current I of the LED module 110. Besides, the PWM circuit 820 receives a control signal Ref2 transmitted from control circuit 140 and sets the pulse width of the pulse outputted from the PWM circuit 820. The control signal Ref2 is configured to modulate the pulse width of the pulse outputted from the driver 130 so as to modulate the driving current I of the LED module 110. In another embodiment, the control circuit 140 modulates the driver 130 by adjusting the voltage to drive the driving current of the LED module 110.

In the embodiments of the invention, the fan generates the convective air flow inside of the illumination device and the illumination device provides a stable light source to light the spaces. Therefore, the illumination device may replace the common high pressure mercury lamp to save energy. Moreover, the illumination may not shut down suddenly. Comparing to the traditional technology, the illumination device of the embodiments of the invention is more convenient and safer for the users.

In conclusion, the embodiment or the embodiments of the invention may have at least one of the following advantages. The illumination device of the embodiments of the invention includes a fan capable of generating a convective air flow to dissipate the heat and avoid the LED module from overheating. The illumination device further has an overheating projection mechanism to avoid burning down the LED module when the fan is failed, so as to provide a stable light source to light the spaces.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A control method of an illumination device, the illumination device comprising a fan and a light emitting diode module capable of emitting a light beam, the control method comprising:
detecting a fan signal of the fan;
determining whether an operation of the fan is abnormal according to the fan signal, wherein a driving current of the light emitting diode module is reduced when the operation of the fan is determined to be abnormal; and
a driving current of the light emitting diode module being reduced to a predetermined range of the normal rated driving current when the fan is determined to be stop according to the fan signal.

2. The control method of the illumination device of claim 1, further comprising:
sending an abnormal signal to a control center outside of the illumination device when the operation of the fan is determined to be abnormal.

3. The control method of the illumination device of claim 1, further comprising:
detecting an environment temperature outside of the illumination device and determining a reduced level of the driving current according to the environment temperature when the operation of the fan is determined to be abnormal.

4. The control method of the illumination device of claim 1, wherein the fan comprises an operation detector configured to generate the fan signal according to the operation of the fan.

5. The control method of the illumination device of claim 1, wherein the predetermined range is greater than or equal to 30% and less than or equal to 90%.

6. The control method of the illumination device of claim 1, wherein the fan comprises a pulse generator configured to generate the fan signal, and a frequency of the fan signal is in direct proportion to the rotation speed of the fan.

7. The control method of the illumination device of claim 6, further comprising:
determining a reduced level of the driving current according to the frequency of the fan signal when the operation of the fan is determined to be abnormal.

8. An illumination device, comprising:
a light emitting diode module comprising at least one light emitting diode;
a fan capable of generating a convective air flow inside of the illumination device and generating a fan signal;
a driver electrically connected to the light emitting diode module and the fan and capable of driving the light emitting diode module to emit a light beam; and
a control circuit electrically connected to the fan and the driver and capable of receiving the fan signal and determining whether an operation of the fan is abnormal according to the fan signal, wherein a driving current of the light emitting diode module is reduced by the control circuit when the operation of the fan is determined to be abnormal according to the fan signal and the driving current of the light emitting diode module is reduced to a predetermined range of the normal rated driving current by the control circuit when the fan is determined to be stop according to the fan signal.

9. The illumination device of claim 8, wherein the driver sends an abnormal signal to a control center outside of the illumination device, when the fan is determined to be abnormal.

10. The illumination device of claim 8, further comprising:
a thermal sensor electrically connected to the control circuit and configured to detect an environment temperature outside of the illumination device;
wherein the control circuit determines a reduced level of the driving current according to the environment temperature when the operation of the fan is determined to be abnormal.

11. The illumination device of claim 8, wherein the fan comprises an operation detector configured to generate the fan signal according to the operation of the fan.

12. The illumination device of claim 8, wherein the predetermined arrange is greater than or equal to 30% and less than or equal to 90%.

13. The illumination device of claim 8, wherein the fan comprises a pulse generator configured to generate the fan signal and a frequency of the fan signal is in direct proportion to the rotation speed of the fan.

14. The illumination device of claim 13, wherein the control circuit determines a reduced level of the driving current according to the frequency of the fan signal when the operation of the fan is determined to be abnormal.

15. The illumination device of claim 8, wherein the control circuit adjusts the driver by using pulse width modulation to drive the driving current of the light emitting diode module.

16. The illumination device of claim 8, wherein the control circuit adjusts the driver by adjusting the voltage to drive the driving current of the light emitting diode module.
